(19) United States
(12) Patent Application Publication
(10) Pub. No.: US 2022/0100071 A1
(43) Pub. Date: Mar. 31, 2022

(54) DYNAMIC WALL FOR AUGMENTED REALITY

(71) Applicant: Thomas Jefferson University, Philadelphia, PA (US)

(72) Inventors: Muthu Govindaraj, Harleysville, PA (US); Karan Hitesh Parikh, Mumbai (IN); Nathan Solomon, Philadelphia, PA (US)

(73) Assignee: Thomas Jefferson University, Philadelphia, PA (US)

(21) Appl. No.: 17/427,316

(22) PCT Filed: Feb. 28, 2020
(86) PCT No.: PCT/US2020/020306

§ 371 Date: Jul. 30, 2021

Related U.S. Application Data
(60) Provisional application No. 62/813,986, filed on Mar. 5, 2019.

(51) Int. Cl. G03B 21/56; G03B 21/606

(52) U.S. Cl. CPC G03B 21/562; G03B 21/606

(57) ABSTRACT

One aspect of the invention provides a system for dynamically repositioning a portion of a screen. The system includes: at least one knife moveable between a first position and a second position; a hook moveable between an open position in which the hook is disengaged from the at least one knife and a closed position in which the hook is removably engaged with the at least one knife; a node located on a back surface of the screen; and a linkage between the node and a distal end of the hook. When the hook is in the closed position and the at least one knife is moved from the first position to the second position, the linkage pulls the node causing the portion of the screen centered around the node to be moved distally away from a remaining portion of the screen.

### CROSS-REFERENCE TO RELATED APPLICATION

This application claims the benefit of priority of U.S. Patent Application Ser. No. 62/813,986, filed Mar. 5, 2019. The entire content of this application is hereby incorporated by reference herein.

### BACKGROUND OF THE INVENTION

Augmented reality (AR) is the superposition of real and virtual objects and scenery to create an interactive environment. An example of augmented reality is a semitransparent screen showing an object (e.g., a sofa) that can be viewed as though placed in a real living room scene behind the semitransparent screen. Another example is the use of AR glasses that depict a real scene captured by cameras and virtual objects superimposed on the scene. A third possibility is the projection of scenes on to a dynamic wall with a transforming surface. Using multiple projectors, scenes in 3D can be created which can be viewed without AR glasses.

### SUMMARY OF THE INVENTION

One aspect of the invention provides a system for dynamically repositioning a portion of an elastomeric or rigid screen. The system includes: at least one knife moveable between a first position and a second position; a hook moveable between an open position in which the hook is disengaged from the at least one knife and a closed position in which the hook is removably engaged with the at least one knife; a node located on a back surface of the elastomeric or rigid screen; and a linkage between the node and a distal end of the hook. When the hook is in the closed position and the at least one knife is moved from the first position to the second position, the linkage pulls the node causing the portion of the elastomeric or rigid screen centered around the node to be moved distally away from a remaining portion of the elastomeric or rigid screen.

This aspect of the invention can have a variety of embodiments. The system can further include a comber board adapted or configured to guide the linkage between the node and the distal end of the hook.

The system can further include a rear frame positioned between the hook and the back surface of the elastomeric or rigid screen. The linkage can further include: a first portion linking the distal end of the hook and the rear frame and a second portion linking the rear frame and the node. The second portion of the linkage can further include a spring.

The system can further include a second knife moveable between a third position and a fourth position and a third or more knives acting in a similar manner to the first and second knife. When the hook is in the closed position and the second knife is moved from the third position to the fourth position, the linkage pulls the node causing the portion of the elastomeric or rigid screen centered around the node to be moved distally away from the remaining portion of the elastomeric or rigid screen to a different distance away from the remaining portion respective to when the at least one hook is moved from the first position to the second position. The third or more knives can move the elastomeric or rigid screen to a different distance away from an original position.

The system can further include an actuator for moving the at least one hook from the first position to the second position. The system can further include a power source connected to the actuator. The power source can be independent from the actuator.

The system can include a plurality of hooks. Any of the plurality of hooks can simultaneously engage with the at least one knife.

Another aspect of the invention provides a method for dynamically repositioning the portion of the elastomeric or rigid screen as described herein. The method includes: moving the hook from the open position to the closed position; and moving the at least one knife from the first position to the second position. The linkage subsequently pulls the node causing the portion of the elastomeric or rigid screen centered around the node to be moved distally away from the remaining portion of the elastomeric or rigid screen.

This aspect of the invention can have a variety of embodiments. Moving the hook from the open position to the closed position can further include: activating or deactivating a magnet located in proximity to the hook.

### BRIEF DESCRIPTION OF THE DRAWINGS

For a fuller understanding of the nature and desired objects of the present invention, reference is made to the following detailed description taken in conjunction with the accompanying drawing figures wherein like reference characters denote corresponding parts throughout the several views.

FIGS. 1 through 4 depict wall assemblies in accordance with embodiments of the claimed invention.

FIG. 5 depicts a workflow process for dynamic wall movement in accordance with an embodiment of the claimed invention.

FIGS. 6A and 6B depicts wall assemblies in accordance other embodiments of the claimed invention.

FIG. 7 depicts a comber board according to an embodiment of the invention.

### DEFINITIONS

The instant invention is most clearly understood with reference to the following definitions.

As used herein, the singular form “a,” “an,” and “the” include plural references unless the context clearly dictates otherwise.

Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from context, all numerical values provided herein are modified by the term about.

As used in the specification and claims, the terms “comprises,” “comprising,” “containing,” “having,” and the like can have the meaning ascribed to them in U.S. patent law and can mean “includes,” “including,” and the like.

Unless specifically stated or obvious from context, the term “or,” as used herein, is understood to be inclusive.

Ranges provided herein are understood to be shorthand for all of the values within the range. For example, a range of 1 to 50 is understood to include any number, combination of numbers, or sub-range from the group consisting 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, or 50 (as well as fractions thereof unless the context clearly dictates otherwise).

### DETAILED DESCRIPTION OF THE INVENTION

### Dynamic Wall Assembly

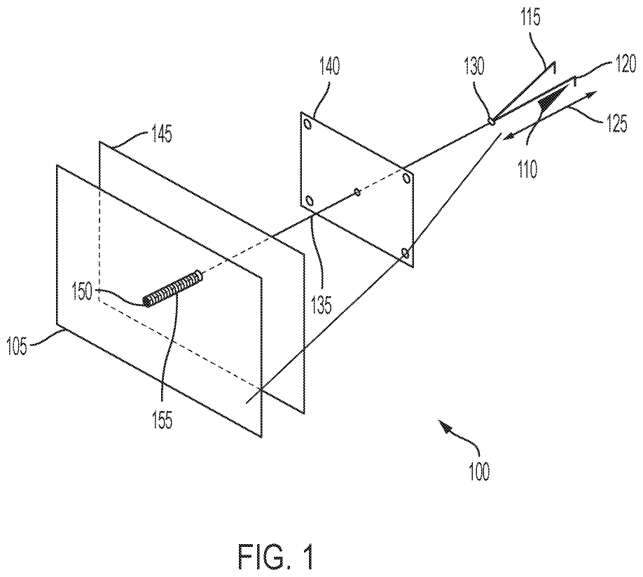

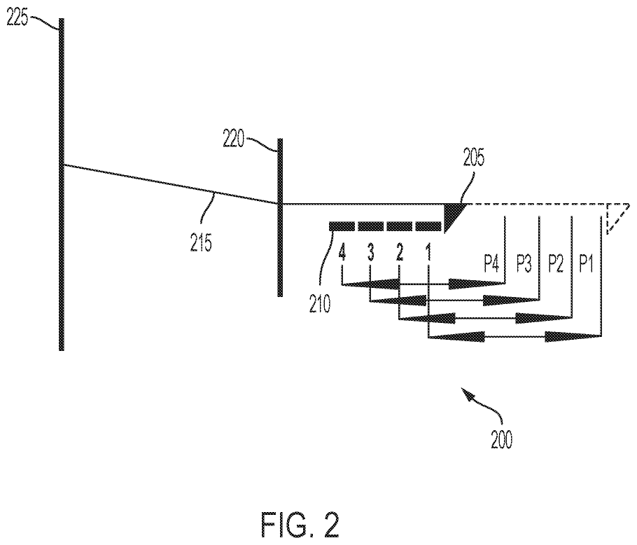

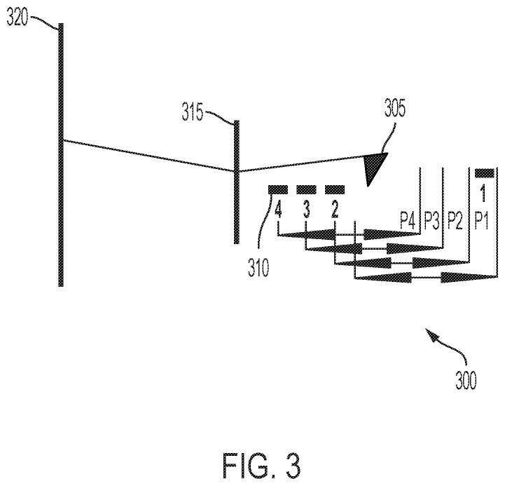

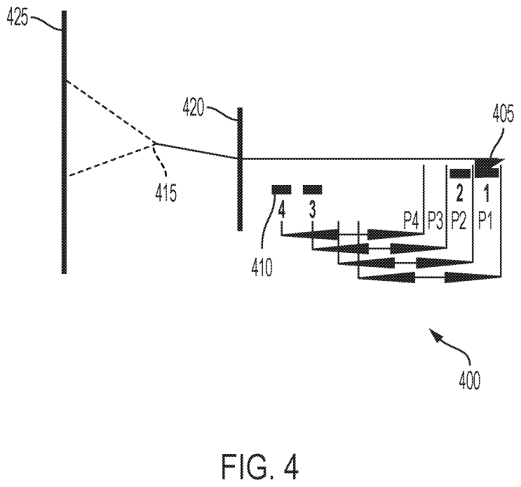

According to an embodiment of the claimed invention, a dynamic wall with a transforming surface is described herein. The dynamic wall may include a number of nodes attached to the back surface of the wall. The nodes may be moveable, such that a portion of the wall connected to the node may move along with the node (e.g., through elastic deformation). This enables different depths of viewing on the front surface of the wall. For example, FIG. 1 depicts a wall assembly 100, FIG. 2 depicts a wall assembly 200, FIG. 3 depicts a wall assembly 300, and FIG. 4 depicts a wall assembly 400.

### Dynamic Wall

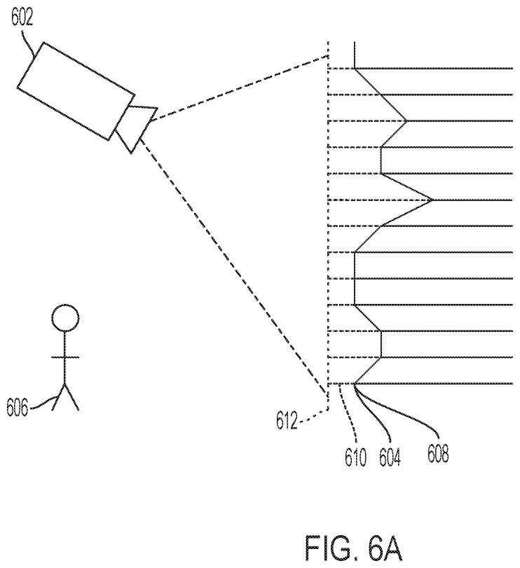

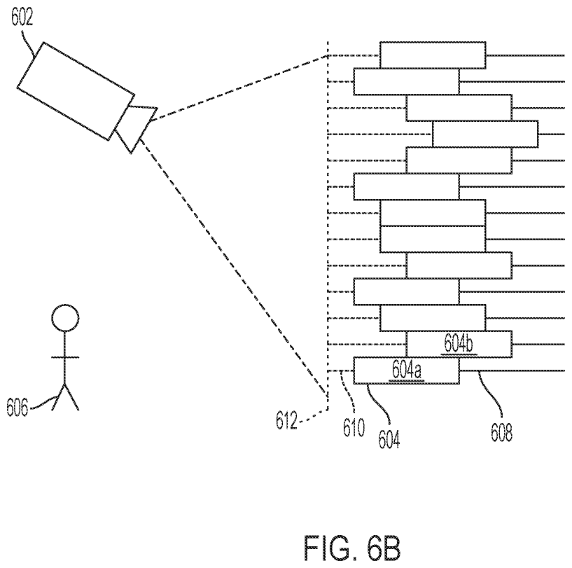

The dynamic wall 100 can have a transformable surface, allowing for different depths of viewing from the front surface. The composition of the wall may vary. For example, the wall may be composed of a rigid material, such as concrete, drywall, plaster, brick, or the like. As depicted in FIG. 6B, the wall 604 may be divided into multiple portions 604a-604n (e.g., the portions 604a-604n are in proximity to and can move independent of each other, but may not be connected to one another), where each portion is connected to a node 608. In this way, the portions of the wall 604a-604n may be individually moved via its attached node 608.

Alternatively, the wall may be composed of an elastomeric material. Examples of elastomeric materials include polyisoprene, polybutadiene, chloropene rubber, butyl rubber, styrene-butadiene, nitrile rubber, ethylene propylene, epichlorohydrin, polyacrylic rubber, silicone rubber, fluorosilicone, fluoroelastomers, perfluoroelastomers, polyether block amides, chlorosulfonated polyethylene, ethylene-vinyl, latex, polytetrafluoroethylene (PTFE), and textile fabrics constructed with synthetic or natural fibers. Suitable elastic materials include spandex, which is available, for example, under the LYCRA® trademark from Invista North America S.A.R.L. of Wichita, Kans. The elastomeric nature of the wall may allow the wall to bend, stretch, or transform when a force is applied to the wall. Thus, an elastomeric example of the wall may allow for a uniform (e.g., not divided into portions) wall while still able to change depths of viewing at particular points of the wall.

### Projector

Referring now to FIGS. 6A and 6B, a projector 602 may be used to project an image onto the wall 604. The projector 602 can, in some cases, be in front of the wall 604, and may thus project an image onto a front surface of the wall 604 (e.g., from the perspective of viewer 606. Alternatively, the projector 602 may be located behind the front surface of the wall 604. In this case, the projector 604 may project an image on a back surface of the wall 604. The projected image may then be transferred to the front surface of the wall 604 (e.g., the wall 604 may be transparent or translucent).

### Node

Nodes (e.g., nodes 150, 215, and 415) may be attached to the back surface of the wall. When a node is moved (e.g., perpendicularly) with respect to the plane defined by the wall, the node may pull a portion of the front surface of the wall back away from the remaining portion of the wall, thereby allowing for different depths of the wall from a front-facing viewing angle.

The wall assembly may include a certain number of nodes. The more nodes connected to the wall, the greater the resolution of augmented reality image on the wall. For example, as many as 8,000 nodes or more may be controlled from a unit that may fit into one square meter volume. Further, the node may be an attachment point on the back surface of the wall, allowing for the hooks discussed below to be attached to the wall.

Referring again to FIG. 6A and 6B, nodes 608 along a wall 604 (an elastomeric wall in FIG. 6A) may be further associated with or paired an opposing tension member 610, which can be further attached to a rigid sheet 612. (Control of nodes behind the wall is omitted for simplicity.) Such an opposing tension system allows for deformation to greater resolution and sharper angles. Opposing tension members 610 and rigid sheet 612 can preferably be as unobtrusive as possible. For example, rigid sheet 612 can be formed from glass or a clear polymer such as or acrylic glass (polymethyl methacrylate or PMMA). Acrylic glass is available under the LUCITE® and PERSPEX® trademarks from Lucite International, Inc. of Cordova, Tenn. Opposing tension members 610 can have a minimal size (e.g., coil springs having a small cross section). In another embodiment, the opposing tension members 610 can include a transparent, translucent, or white elastic. In still another embodiment, the opposing tension members 610 can run parallel to the rigid sheet 612 to engage with a tensioner such as a spring out of the viewing plane while turning at a hole or eyelet to engage with the wall 604. Such an architecture allows for use of transparent, but generally inelastic members such as monofilament lines.

### Hook

Each node may be connected to a hook (e.g., hooks 110, 205, 305, and 405). The hook may be linked to the node through a linkage, which in some cases may be a cord or spring (e.g., linkage 135). The linkage may be attached to a distal end of the hook (e.g., the hook end may be facing away from the wall). When the hook is moved (e.g., perpendicularly) away from the plane defined by the wall, the hook may also pull the linkage and attached node away from the width of the wall, thereby creating a difference in depth on a portion of the wall centered around the node. For example, FIG. 4 depicts node 415 displaced from the wall 425 (with the dashed line representing a cross-section of the deformed portion of the wall 425).

Further, the hook may composed of a rigid composition to allow the hook to grasp knives discussed below. Examples of materials the hook may be comprised of include metals, plastics, woods, etc.

### Hook Hinge

The hook may include a hinge, such as hinge 130. The hinge may allow the hook to be positioned in either an open position 115 or a closed position 120. The closed position may allow for the hook to be in contact with one or more knives described below. When in an open position, the hook may be isolated from contact with any knives. This isolation caused by the closed position may maintain the hook, as well as the corresponding attached node, in their current positions. Further, the hook may be moved from the closed position to the open position, and vice versa, through various mechanisms. For example, a magnet may be attached to the hook, and another magnet mechanism may be located in proximity to the hook. To lift the hook into the open position, the magnet mechanism may be activated (e.g., magnetized, moved closer to the hook, etc.). The magnet on the hook may be attracted to the magnet mechanism, and the hook may subsequently be lifted into the open position. To move the hook into the closed position, the magnet mechanism may be turned off, and the hook may be moved into the closed position via gravitational force. Other mechanisms for actuating hooks include electromagnetics, pneumatics, hydraulics, and the like.

### Knife

Each node and hook pairing may also include at least one corresponding knife, such as knives 210, 310, and 410. The knife may be an object that can move into various distances (e.g., perpendicularly) away and towards a plane defined by the wall. For example, each knife may be moved into a first position and a second position, where the second position is perpendicularly further away from the width of the wall.

The corresponding hook may be moved perpendicularly away and towards the width of the wall based on the movement of the knife and the position of the hook. If the hook is in the open position, the hook and node are immobile regardless of the position of the knife. Alternatively, if the hook is in the closed position, the hook may be in contact with the knife and can thus be moved away and towards the width of the wall. For example, if the hook is in the closed position and the knife is in the first position, the hook may be moved perpendicularly away from the width of the wall by the knife being moved from the first position to the second position. This movement may also move the node attached to the back surface of the wall perpendicularly away from the width of the wall, which may in turn create a displacement of a portion of the wall centered around the node. Likewise, if the hook is in the closed position and the knife is in the second position, the hook may be moved perpendicularly towards from the width of the wall by the knife being moved from the second position to the first position. This movement may also move the node attached to the back surface of the wall perpendicularly towards the width of the wall, which may in turn remove the displacement of the portion of the wall centered around the node.

Further, the knife may be in a shape so that the hook may attach to the knife while in the closed position. The knife may also be composed of rigid material, such as metals, plastics, woods, etc. Additionally, each hook and node pairing may include more than one knife, where each knife includes different distances away from the wall surface (e.g., different locations for the first position and the second position). This may allow for the hook and attached node to be moved in varying degrees of distance away from the wall surfaces, thereby providing a finer granularity in screen resolution. For example, FIG. 2 depicts four knives 210, although other numbers such as eight are within the spirit of the invention. In the case of FIG. 2, each of the knives 210 are in their respective first positions, and thus the hook 205 and corresponding node are in their original positions. In FIG. 3, the hook 305 is in an open position. Thus, even though a first knife of the knives 310 has been moved away from the wall 320, the corresponding node does not, which maintains the original position of the wall 320. In FIG. 4, the hook 405 is in a closed position, and the second knife of the set of knives 410 is moved away from the screen 425. The hook 405 connects to the second knife and is pulled away from the screen, along with the corresponding node 415. The movement by the node 415 generates a displacement on the screen 425 centered around the node 415.

### Knife Actuator

Not shown in the figures is an actuator for moving the knives to their respective locations. Some examples of actuators that may be used for the knives include hydraulic, pneumatic, electric, thermal, magnetic, or mechanical. Additionally, the control functions of the actuator may be separate from the actuator, which allows for increased complexity for the wall assembly. Various control techniques and devices for both knives and hooks used in a Jacquard loom can be applied to the invention.

### Separation of Control and Power

In one embodiment of the invention, the hooks are connected to the screen (or any flexible medium) and the knives move the hooks to different positions. One knife can move several hooks, as much as hundreds of them. This allows the control of the whole AR surface, which may have hundreds of nodes or points of connection, by just a few knives. Thus, only a few power sources (e.g., motors) are required to control a surface. This arrangement gives a tremendous advantage over controlling the surface with individual motors for each node. In addition to avoiding the cost and complexity of a 1:1 motor-to-node ratio, pulling multiple nodes with a single knife allows for better matching of motors to the significant forces that can be required to pull nodes (whether one or multiple) and supports the use of high-performance motors that may provide faster actuation speeds.

In some embodiments, each motor-knife pair can provide motive power to over 100, 200, 400, 800, and the like hook-node pairs.

### Comber Board

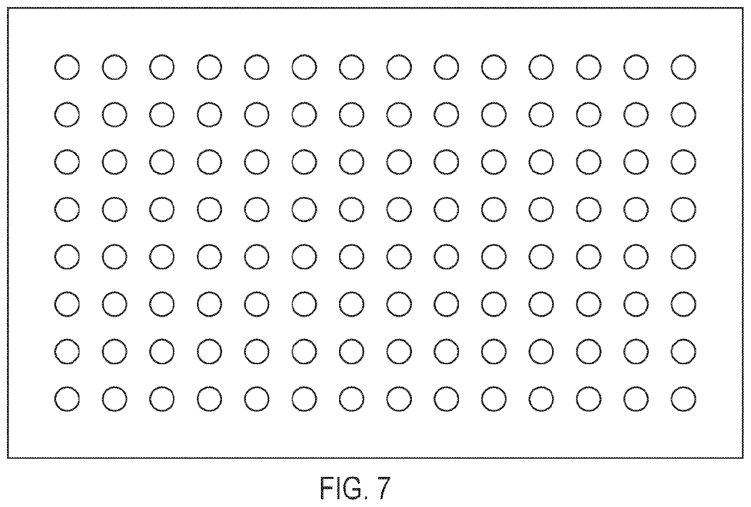

A comber board may be used in the wall assembly to guide the various linkages from the hooks and corresponding nodes. Examples of the comber board include comber boards 140, 220, 315, and 420. Referring now to FIG. 7, the comber board may include a set of holes, where the holes may each guide either a single or multiple linkages between the nodes and the hooks. The comber board may mitigate the possibility of linkage entanglement or severance due to the complexity of the moving parts of the wall assembly.

### Rear Frame

In some cases, the wall assembly may include a rear frame 145 of the wall. The rear frame 145 may be attached to a node of the wall through a linkage 155, such as a spring. The rear frame may be attached to the hook via another linkage 135. When the hook is pulled perpendicularly away from the wall, the rear frame may be pulled as well. The rear frame may in turn pull the attached node away from the wall, thereby creating the displacement.

### Exemplary Process

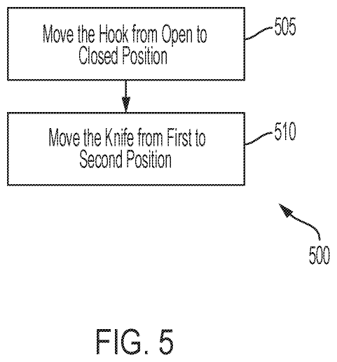

FIG. 5 depicts an exemplary process flow 500 according to an embodiment of the invention. The process flow 500 may be implemented by a wall assembly, such as wall assemblies 100, 200, 300, and 400 of FIGS. 1 through 4, respectively.

At Step 505, the hook is moved from an open position to a closed position. The open position may correspond to a hook being disengaged from at least one knife, and the closed position may correspond to the hook being removably engaged with the at least one knife.

At Step 510, the at least one knife is moved from the first position to the second position. A linkage between a node connected to an elastomeric screen and the hook subsequently pulls the node causing the portion of the elastomeric screen centered around the node to be moved distally away from the remaining portion of the elastomeric screen.

### Equivalents

Although preferred embodiments of the invention have been described using specific terms, such description is for illustrative purposes only, and it is to be understood that changes and variations may be made without departing from the spirit or scope of the following claims.

### INCORPORATION BY REFERENCE

The entire contents of all patents, published patent applications, and other references cited herein are hereby expressly incorporated herein in their entireties by reference.

1. A system for dynamically repositioning a portion of an elastomeric or rigid screen, the system comprising:
at least one knife moveable between a first position and a second position;
a hook moveable between:
an open position in which the hook is disengaged from the at least one knife; and
a closed position in which the hook is removably engaged with the at least one knife;
a node located on a back surface of the elastomeric or rigid screen; and
a linkage between the node and a distal end of the hook;
wherein when the hook is in the closed position and the at least one knife is moved from the first position to the second position, the linkage pulls the node causing the portion of the elastomeric or rigid screen centered around the node to be moved distally away from a remaining portion of the elastomeric or rigid screen.

2. The system of claim 1, further comprising:
a comber board adapted or configured to guide the linkage between the node and the distal end of the hook.

3. The system of claim 1, further comprising:
a rear frame positioned between the hook and the back surface of the elastomeric or rigid screen; wherein the linkage further comprises:
a first portion linking the distal end of the hook and the rear frame; and
a second portion linking the rear frame and the node.

4. The system of claim 3, wherein the second portion of the linkage further comprises a spring.

5. The system of claim 1, further comprising:
a second knife moveable between a third position and a fourth position, wherein when the hook is in the closed position and the second knife is moved from the third position to the fourth position, the linkage pulls the node causing the portion of the elastomeric or rigid screen centered around the node to be moved distally away from the remaining portion of the elastomeric or rigid screen to a different distance away from the remaining portion respective to when the at least one hook is moved from the first position to the second position; and
a third or more knives acting in a similar manner to the first and second knife, wherein the third or more knives move the elastomeric or rigid screen to a different distance away from an original position.

6. The system of claim 1, further comprising:
an actuator for moving the at least one hook from the first position to the second position.

7. The system of claim 6, further comprising:
a power source connected to the actuator, wherein the power source is independent from the actuator.

8. The system of claim 1, wherein:
the system comprises a plurality of hooks; and
any of the plurality of hooks can simultaneously engage with the at least one knife.

9. A method for dynamically repositioning the portion of the elastomeric or rigid screen of claim 1, the method comprising:
moving the hook from the open position to the closed position; and
moving the at least one knife from the first position to the second position; wherein the linkage subsequently pulls the node causing the portion of the elastomeric or rigid screen centered around the node to be moved distally away from the remaining portion of the elastomeric or rigid screen.

10. The method of claim 9, wherein moving the hook from the open position to the closed position further comprises:
activating or deactivating a magnet located in proximity to the hook.
